(19) United States
(12) Patent Application Publication
(10) Pub. No.: US 2009/0317167 A1
(43) Pub. Date: Dec. 24, 2009

(54) DELIVERY SYSTEM

(75) Inventors: Leo Clifford Pires, Basking Ridge, NJ (US); Roger Hwang, Maple (CA); Rahul Bose, New Delhi (IN); Santosh Mohapatra, New Delhi (IN); Anjani Lal Pandey, Haryana (IN); Iti Seth, New Delhi (IN); Koushik Kohli, Ghaziabad (IN)

Correspondence Address: PATTERSON & SHERIDAN L.L.P. NJ Office, 3040 Post Oak Boulevard, Suite 1500, Houston, TX, 77056-6582, US

(73) Assignee: Zen Design Solutions Limited, Wanchai (HK)

(21) Appl. No.: 12/144,255

(22) Filed: Jun. 23, 2008

(51) Int. Cl. B43K 21/16; B67D 5/00

(52) U.S. Cl. 401/65; 222/137

(57) ABSTRACT

The present invention generally is a delivery system for dispensing product(s) in adjustable quantities comprising a body, said body having at least one cavity for housing the product(s) and a plunger or a piston and rod assembly, an actuator being in communication with the cavity in the body, said actuator having an inclined profile at one of its ends which is in communication with the body, and a means for changing the position of the incline of the actuator with respect to the body wherein changing the position of the inclined profile of the actuator with respect to the body delivers different quantities of the product(s).

### BACKGROUND

1. Field of the Invention

Embodiments of the present invention generally relate to a delivery system for dispensing product(s) in adjustable and/or variable quantities. More particularly, the present invention relates to a delivery system for dispensing a product in a user-defined dosage. Also provided is a delivery system that dispenses at least two components in a user-defined ratio.

2. Description of the Related Art

There are certain consumer products which are required to be used in a particular quantity/ratio by the user. For such products, consumers seek a package that provides them with the convenience of adjusting the required dosage of a product while in case of two products being used, the user would go for a package that allows him/her to adjust the ratio as per his/her requirement. Further, in certain applications, the incompatibility of the component ingredients dictates that the components remain separate until the moment of use. In such a case, containers having two cavities are used to keep the substances separate until they are dispensed. Such dual packages can deliver products while preserving the activity and effectiveness of the individual components.

Previous attempts to deliver a required dosage or to adjust the mixing ratio have been made by adjusting the stroke of the pump plunger which in turn has been effected by way of the pumps being mounted pivotally on the lever acting on the pump which is adjustable. The pivoting motion of the pumps is made possible by a ball joint. However, such a mechanism is more complex to be manufactured. For example U.S. Pat. No. 5,971,210 to Brugger describes a device that is relatively complex, having a mechanism that enables actuation of a pushbutton to be transformed into strokes of greater or shorter length for actuating pump rods.

U.S. Pat. No. 6,464,107 to Brugger, discloses a proportioning dispenser for proportioning two components in an adjustable ratio. The products are supplied from the compartments via a pump unit wherein the adjustment of the mixing ratio is effected by a transmission member, the point of application of which is adjustable with respect to the two pump units. The actuation of the pump units is performed by a pivotable transmission member, the pivoting axle of which can be displaced relative to the operating members of the pump unit. Thus, it is made possible to change the point of application of the transmission member at the pump units and thus their stroke by changing the position of the pivoting axle relative to the pump units. The dispenser uses a circumferential rotating pivot/hinged mechanism to dial the desired ratio, however it is of a structure that is relatively complex.

Also U.S. Pat. No. 7,222,752 to Ponton discloses a dispenser device for dispensing at least two components in an adjustable ratio. The device comprising a plurality of reservoirs for containing respective substances, a pump associated with each said reservoir, a pushbutton, at least one elastically-deformable transmission member associated with at least one of the control members, and at least one adjustment member for adjusting an end-of-stroke position of the displacement at least of the control member associated with the transmission member. Each pump unit in the device is associated with a movable control member which, when actuated, causes the substance contained in the reservoir associated with the pump to be dispensed. Further, the at least one elastically-deformable transmission member is disposed in such a manner as to transmit displacement of the pushbutton to the at least one control member in order to dispense substance(s). The adjustment member comprises a plurality of surfaces situated at different heights and against which the actuator members can come to bear when the associated control members have reached their respective end-of-stroke positions.

However, the mechanism in the above device is complex and difficult to manufacture and moreover, it has a shortcoming that the user might have to keep on pressing the pushbutton for the product to be dispensed as it takes time for the control member to reach their respective end-of-stroke position.

Although the existing dosage/proportioning dispensers are being used for products, most of them still have the defect that the adjustment mechanism for adjusting the mixing ratio has a comparably complicated design. The requirement of either the cartridges or a transmission member having to be pivotally mounted is comparably complicated and expensive. Moreover, most of the existing proportioning dispensers utilize pump mechanisms to deliver at least two products in adjustable proportions and have more number of parts which are again costly to manufacture. Another shortcoming of these dispensers is that they are difficult to be made portable as they can not be scaled down to smaller dimensions such as that of a pen.

Therefore, there is a need in the art for a delivery system that dispenses a product in adjustable quantities or at least two products in a user-defined ratio, has an easy manufacturability and is less expensive. The present invention therefore, is directed to a delivery system that delivers as effectively as a pump delivery system and delivers the products in a user-defined ratio/dosage and at the same time is cost-effective in manufacturability. Also, the delivery system of the present invention is smaller in size and easy to use by virtue of it being efficiently portable as well as having reduced chances of dialer malfunction.

### SUMMARY

The present invention generally is a delivery system for dispensing product(s) in adjustable and/or variable quantities. The delivery system of the present invention may also dispense at least two products in variable proportions as may be desired by a user. The delivery system according to the invention has essentially simpler design as compared to the proportioning dispensers described in the Description of Related Art as the number of movable parts is reduced. The delivery system of present invention is simple in construction and reliable as to its operation.

According to an embodiment of the invention there is provided a delivery system for dispensing a product in a user-defined dosage/ratio. There is also provided a delivery system that is easy to operate by a user and is portable as it can be produced in the form of a pen as well.

In accordance with an embodiment of the invention, the delivery system comprises a body, an actuator wherein the actuator has an inclined profile at one of its ends that is in communication with the body. The delivery system further comprises of a means for changing the position of the incline of the actuator with respect to the body. The said means is arranged so as to be operatively connected to the actuator which helps in positioning the actuator for dispensing different ratios/dosages. Further, the body has at least one cavity for housing the product(s) and a plunger or a piston and rod assembly.

According to yet another embodiment of the invention, the cross-section of the actuator is radially symmetrical and is characterized in that it has an inclined profile similar to a ramp at one of its ends, more particularly at its end proximal to the cavity of the body. The actuator may have a cavity in and embodiment having an extended piston rod so that the cavity receives the extended piston rod. The actuator may actuate a plurality of dispensing units by aligning its end having an inclined ramp profile with specific parts of the piston assembly that operate the dispensing units. Further, the angle of inclination of the ramp in engagement with the piston/plunger assembly may define the total amount of the product dispensed by the respective piston/plunger assembly.

According to yet another embodiment of the invention, the piston assembly comprises of a piston, a piston rod, an anti-slip jaw and a propeller jaw. The terms “Anti-slip jaw” and “Propelling jaw” as used herein refer to a radially symmetrical component with cut outs in the center, said cut-outs defining formation of flanges, said flanges making the jaw to be elastically deformable towards one axis. The piston rod is profiled wherein the profiles serve as appropriate means of engagement with the anti-slip and the propeller jaws. The piston rod may also be profiled in a manner that there are present ratchets on the rod periphery. The piston assembly further comprises a stationary holder for holding the anti-slip jaw, a propelling holder that holds the propelling jaw and a biasing member biasing the movement of both the holders and in turn both the jaws. The propeller jaw and the anti-slip jaw control the movement of the piston rod. The stationary holder is so arranged inside the cavity of the body that it remains stationary whereas the propelling holder is arranged to be movable inside the cavity.

In accordance with another embodiment of the invention, the actuator when caused to push the propelling holder results in the propelling jaw being displaced which in turn causes the piston rod to move/displace, also anti-slip jaw being flexible allows the piston rod to move further upwards and displace the piston which causes the fluid to be dispensed. As soon as the propelling holder moves backwards to come back to its earlier position, due to the action of the biasing member, the anti-slip jaw being stationary engages with the profile on the piston rod and holds it in place for next actuation. The anti-slip jaw therefore helps in gripping the piston rod thereby restricting the piston rod to move down after it is caused to advance and thereby enables the consecutive displacement of product upon reactivation of the actuator.

According to yet another embodiment of the invention, the actuator having an inclined profile may further have a step profile on the incline which provides an efficient push for the piston rod to be displaced. Alternatively, the profile on the incline may be executed as a smooth plane, stepped or teeth profile or any other suitable profile.

According to yet another embodiment of the invention, the means for changing the position of the incline of the actuator and the actuator may be biased by a biasing member that provides smooth actuation by the actuating member.

According to another embodiment of the invention, the means for changing the position of the incline of the actuator may be in the form of a dialer. Also, rotation of such a dialer results in simultaneous rotation of the actuator. The incline of the actuator defines a top end and a bottom end of the incline. As the actuator has an inclined profile, its displacement causes it to be positioned in such a way that its peripheral inclined profile top end touches the propelling holder placed in the cavity, thereby resulting in different dosages to be dispensed depending on the section of the incline profile touching the propelling holder.

According to yet another embodiment of the invention, the actuator may be locked with respect to the dialer such that it does not get actuated accidentally.

Further, in case of a dual delivery system, the body may define two cavities in it wherein each of the cavities houses a plunger/piston and rod assembly and the two products respectively. During operation, the means for changing the position of the incline of the actuator, for example a dialer is rotated to fix a ratio to be dispensed which causes the actuator to be positioned in such a way that its peripheral incline profiled top end touches the piston assemblies of the two product cavities. Upon actuating the actuator, the top end and the bottom end of the incline profile displace to a certain distance. The product displacement is thus caused by the movement of the actuator. As the position of the incline profile on the actuator is changed relative to the piston assemblies, the displacement of the respective piston rods and therefore the respective pistons is also changed such that the proportioning ratio of different components relative to one another is adjusted. Moreover, as there are no pivoted movable parts in the present delivery system, the chances of dialer malfunction are reduced as compared to the existing ratio/dosage delivery systems.

Delivery system of the present invention can be used to dispense a wide variety of consumer and industrial products related to cosmetic, skin care, hair care, oral care, personal care, pharmaceutical, wound care, orally administrable products, home-care or adhesives.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of the delivery system according to one embodiment of the present invention.

FIG. 2 is an isometric view of the delivery system with the cap removed.

FIG. 3 is an exploded view of the delivery system as shown in FIG. 1.

FIG. 4 is an exploded view of the delivery system according to another embodiment of the invention.

FIG. 5 is a top view of the actuator of the delivery system as shown in FIG. 1.

FIG. 6 is a side cross-sectional view of the actuator of the delivery system as shown in FIG. 5.

FIG. 7 is a third angle projection view of the actuator of the delivery system as shown in FIG. 5.

FIG. 8 is a side view of the actuator of the delivery system as shown in FIG. 5.

FIG. 9 is a cross-sectional view of the delivery system as shown in FIG. 1.

FIG. 10 is an enlarged fragmentary view of the arrangement of the parts of the delivery system as shown in FIG. 9.

FIG. 11 is a cross-sectional view of the delivery system as shown in FIG. 9 showing the position of the actuator for dispensing the products in about a 100:0 ratio.

FIG. 12 is a cross-sectional view of the delivery system as shown in FIG. 9 showing the position of the actuator for dispensing the products in about a 75:25 ratio.

FIG. 13 is a cross-sectional view of the delivery system as shown in FIG. 9 showing the position of the actuator for dispensing the products in about a 0:100 ratio.

FIG. 14 is a perspective of the actuator having a stepped incline profiled end according to another embodiment of the invention.

FIG. 15 is a top view of the actuator having a stepped incline profiled end as shown in FIG. 14.

FIG. 16 is a side cross-sectional view of the actuator having a stepped incline profiled end as shown in FIG. 14.

FIG. 17 is a third angle projection view of the actuator having a stepped incline profiled end as shown in FIG. 14.

FIG. 18 is a side view of the actuator having a stepped incline profiled end as shown in FIG. 14.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

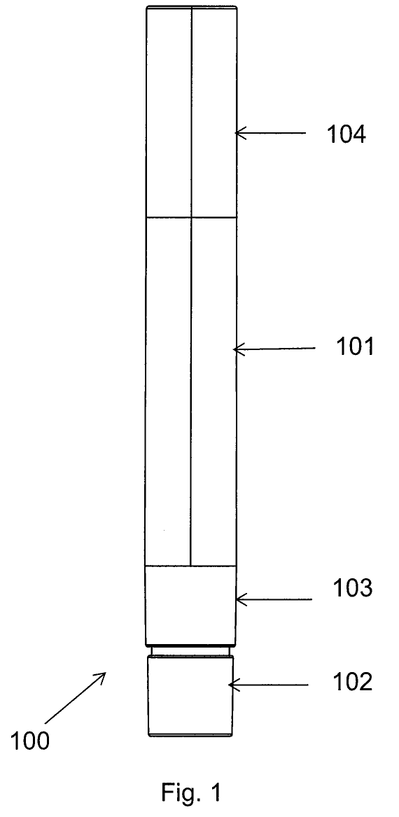

FIG. 1 is one embodiment of the delivery system according to one embodiment of the present invention.

The terms “Anti-slip jaw” and “Propelling jaw” as used herein refer to a radially symmetrical component with cut outs in the centre, said cut-outs defining formation of flanges, said flanges making the jaw to be elastically deformable towards one axis. Also, the terms “propelling holder” and “stationary holder” refer to the components capable of holding the propelling jaw and the anti-slip jaw respectively.

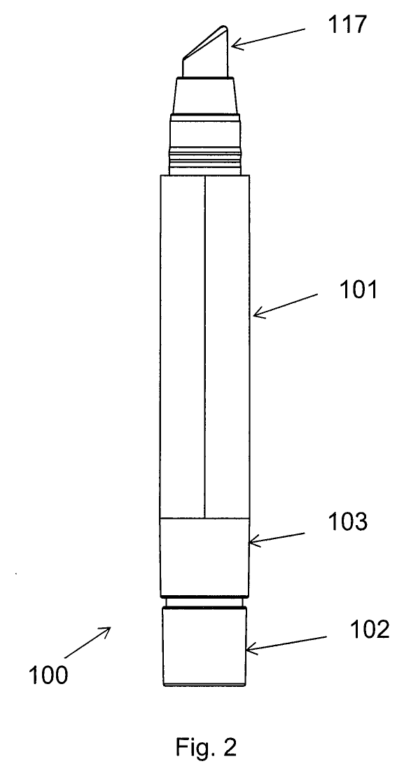

As shown in FIGS. 1 to 2, the delivery system 100 comprises a body 101, an actuator 102, a dialer 103 and a cap 104. The actuator 102 provides the force to actuate the movement of the product in the delivery system. The actuator 102 is in communication with the body 101 while the dialer 103 is arranged so as to be operatively connected to the actuator 102 which helps in positioning the actuator 102 for dispensing different ratios or dosages. Further, the body 101 has at least one cavity for housing the product(s) and a piston and rod assembly 106.

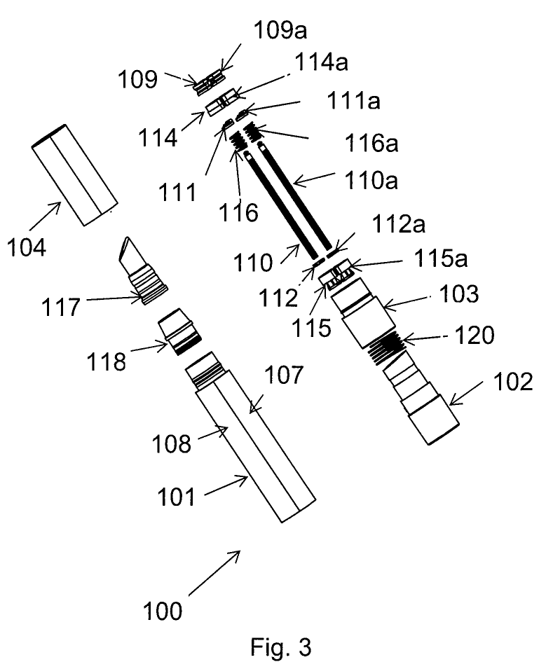

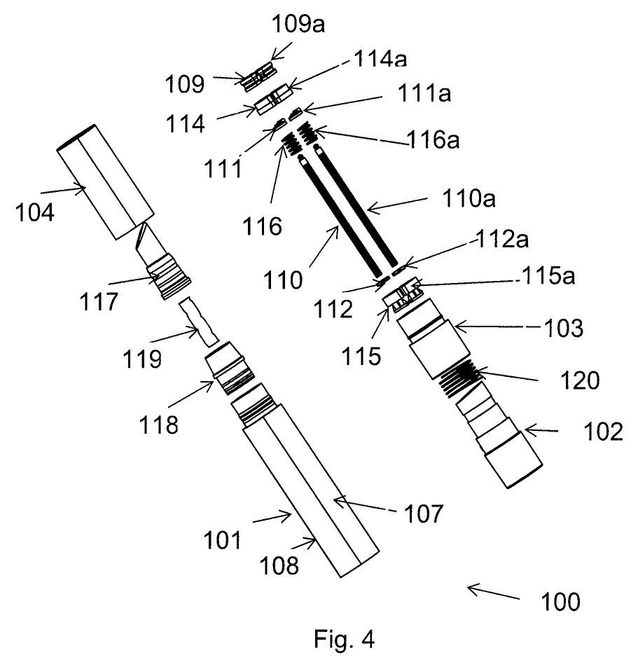

As illustrated in FIGS. 3 and 4, the body 101 of the delivery system 100 has two cavities 107 and 108 that house two different products and the piston assembly 106. The actuator 102 and the dialer 103 are operatively connected so that the dialer 103 when rotated changes the position of the actuator 102. The dialer 103 may be operated manually, mechanically, magnetically, electrically or by any other suitable mode. Further, a biasing member 120 is placed between the actuator 102 and the dialer 103 that helps in smooth actuation by the actuator 102. The piston assembly 106 housed in each of the cavity of the body 101 comprises of a piston 109, a piston rod 110, an anti-slip jaw 111 and a propeller jaw 112. The piston rod 110 as seen has a profile where there are present ratchets 113 on the rod periphery. The piston assembly 106 further comprises a stationary holder 114 for holding the anti-slip jaw 111, a propelling holder 115 that holds the propeller jaw 112 and a biasing member 116 biasing the movement of both the holders and in turn both the jaws. The stationary holder 114 is so arranged inside the cavity of the body 101 that it remains stationary whereas the propelling holder 115 is arranged to be movable inside the cavity of the body 101. The delivery system further comprises an applicator 117 which is housed in an applicator sleeve 118. Also, as represented in FIG. 4, the products may also be dispensed after being mixed inside the system by the help of a means for mixing the products 119.

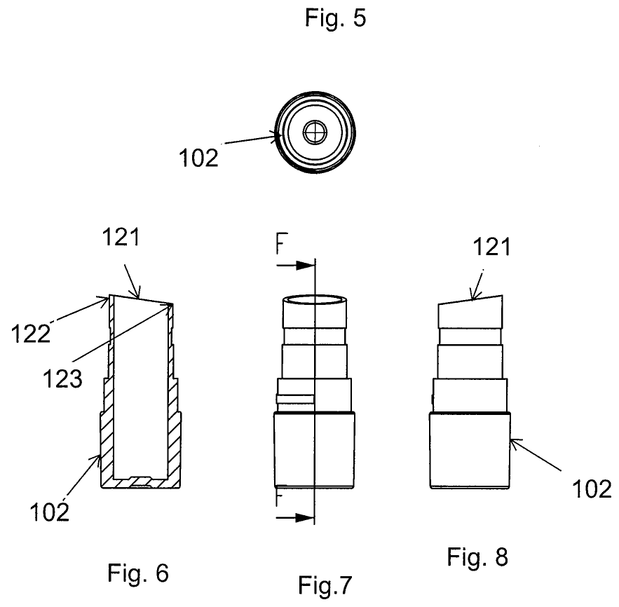

As represented in FIGS. 5 to 8, the cross-section of the actuator 102 is radially symmetrical and is characterized in that it has an inclined/ramp profile 121 at one of its ends, more particularly at its end proximal to the cavity/body 101 and the actuator has a cavity to receive the extended piston rod. Further, the angle of inclination of the ramp profile defines the total amount of the product dispensed.

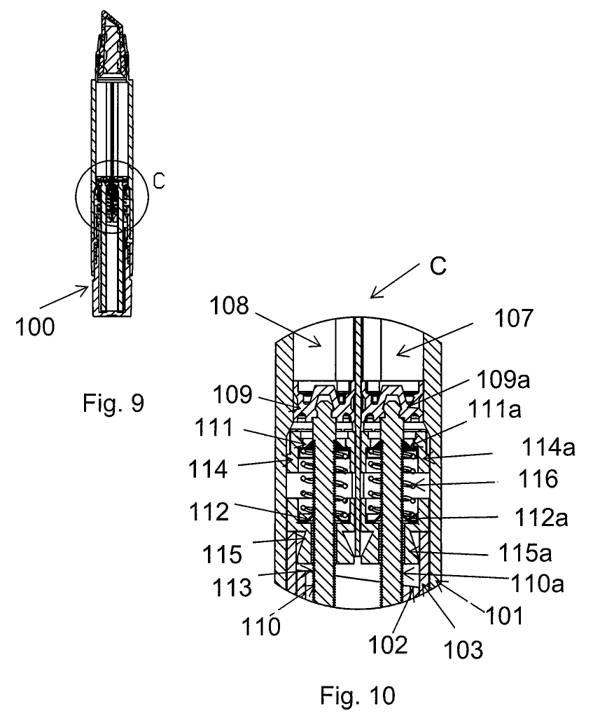

As shown in FIGS. 9 and 10, the actuator 102 actuates the two dispensing units by aligning its end having an inclined profile 121 with specific parts of the piston assembly 106 that operate the dispensing units. Further, the angle of inclination of the profile 121 defines the total amount of the product dispensed. Also, the propeller jaw 112 and the anti-slip jaw 111 control the movement of the piston rod 110. The actuator 102 when actuated pushes the propelling holder 115 that results in the propeller jaw 112 being displaced which in turn causes the piston rod 110 to displace, also anti-slip jaw 111 being flexible allows piston rod 110 to move further upwards and displace the piston 109 which causes the fluid to be dispensed. As soon as the propelling holder 115 moves backwards to come back to its earlier position, due to the action of the biasing member 116, the anti-slip jaw 111 being stationary engages with the ratchets 113 on the piston rod 110 and holds it in place for next actuation. The anti-slip jaw 111 therefore helps in gripping the piston rod 110 thereby restricting the piston rod 110 to move down after it is caused to advance and thereby enables the consecutive displacement of product upon reactivation of the actuator.

Rotation of the dialer 103 results in simultaneous rotation of the actuator 102. The incline of the profile 121 defines a top end 122 and a bottom end 123 of the incline. As the actuator 102 has an inclined profile, its displacement causes it to be positioned in such a way that its peripheral ramp profiled end touches the propelling holders 115, 115a placed in the cavities 108 and 107 respectively, thereby resulting in different quantities to be dispensed depending on the section of the incline/ramp profile 121 touching the propelling holder.

Further, as shown in FIG. 10, in the delivery system 100, the body 101 defines two cavities 107 and 108 wherein each of the cavities houses a piston and rod assembly 106 and the two products respectively. During operation, the dialer 103 is rotated to fix a ratio of the two products to be dispensed which causes the actuator 102 to be positioned in such a way that its peripheral incline/ramp profiled top end 122 touches the piston assembly in the cavity 107 while the bottom end 123 touches the piston assembly of the cavity 108. Upon actuating the actuator 102, the top end 122 and the bottom end 123 of the incline/ramp profile 121 displace to a certain distance resulting in simultaneous axial displacement of both the piston rods 110, 110a and thereby the pistons 109, 109a. The product displacement is caused by the movement of the actuator 102. As the position of the incline/ramp profile 121 on the actuator 102 is changed relative to the piston assemblies of the two cavities 107 and 108, the displacement of the piston rods and thereby the piston is also changed such that the proportioning ratio of different components relative to one another is adjusted.

For ratio dispensing the position of the actuator is changed with respect to the dispensing units in the cavities by the user. The change in the positions may be effected by the help of a means for changing the position of the incline of the actuator, for example a dialer 103.

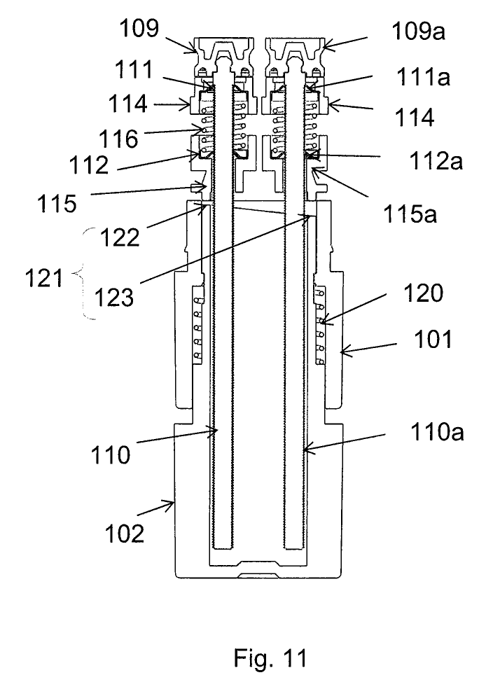

FIGS. 11 through to 13 illustrate the dispensing of products in different ratios by change in the position of the actuator 102. FIG. 11 shows the dispensing of products in a ratio of about 100:0 for the products stored in cavities 108 and 107 respectively. This occurs when the actuator is caused to be placed in a position where top end 122 of the incline/ramp profile 121 of the actuator 102 touches the propelling holder 115 of the cavity 108 while the bottom end 123 is at a distance from the propelling holder 115a of the cavity 107, due to which when the actuator is actuated, its movement occurs such that the top end 122 is able to push the propelling holder 115 of cavity 108 while the propelling holder 115a of the cavity 107 is not at all pushed thereby resulting in 100% evacuation of product stored in cavity 108 and no displacement of fluid in cavity 107.

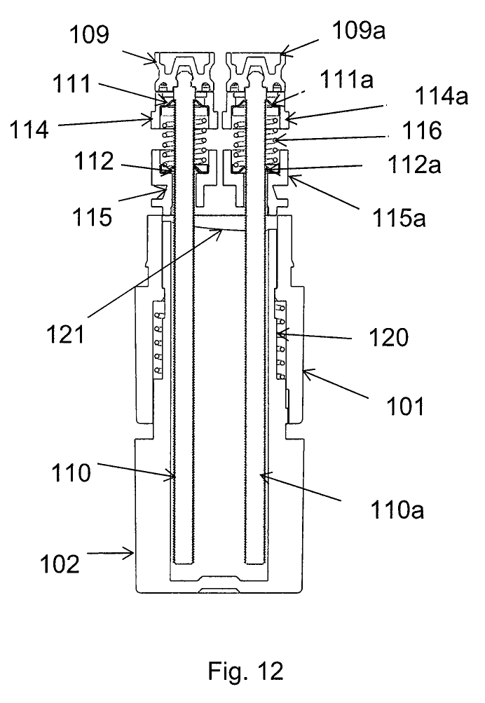

Further, when the actuator is displaced from its position in FIG. 11 to a position as shown in FIG. 12, the periphery at a distance from the top end 122 of the incline/ramp profile 121 of the actuator 102 touches the propelling holder 115 of the cavity 108 while the propelling holder 115a of the cavity 107 touches a portion away from the bottom end 123 of the incline/ramp profile 121, due to which when the actuator 102 is actuated, its movement occurs such that the propelling holder 115 of cavity 108 is pushed to a greater extent than the propelling holder 115a of the cavity 107 thereby resulting in about a 75:25 ratio dispensing of the product stored in cavity 108 and cavity 107, respectively.

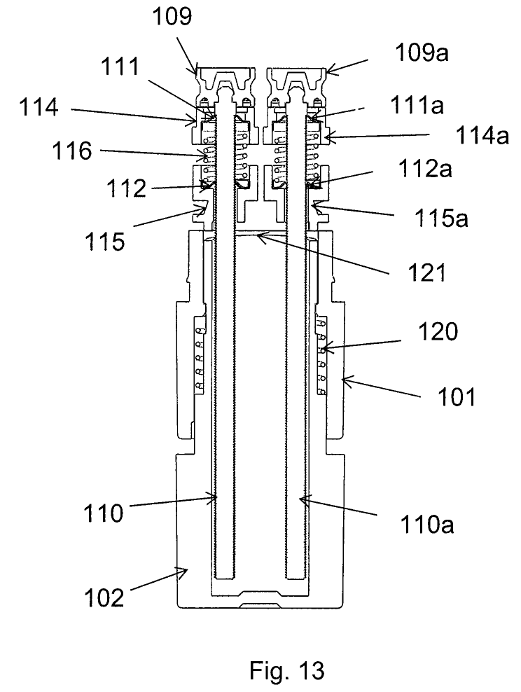

As the actuator is displaced further from its position in FIG. 12 to a position as shown in FIG. 13, the propelling holders 115, 115a of both the cavities 108 and 107 respectively are touched by the middle portion of the incline/ramp profile 121 of the actuator 102, due to which when the actuator 102 is actuated, its movement occurs such that the propelling holders 115, 115a of both the cavities are pushed to an equal distance thereby resulting in a 50:50 ratio dispensing of the product stored in cavity 108 and cavity 107, respectively.

Corresponding intermediate positions of the incline/ramp profile 121 of the end of actuator proximal to the propelling holders, respectively, result in corresponding intermediate ratios of the displacement volumes of the pistons 109, 109a, so that these are continuously variable between 100:0 and 0:100 for each product.

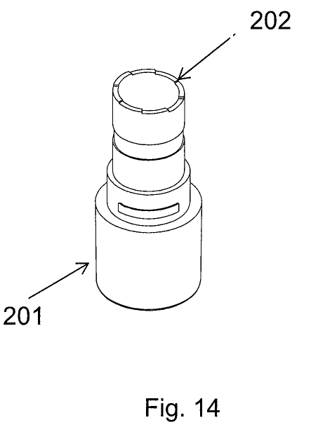

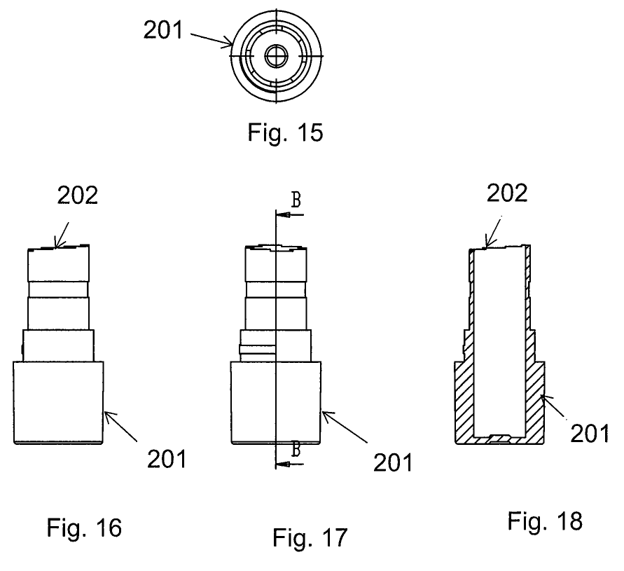

FIGS. 14 to 18 show an actuator according to another embodiment of the invention. As shown in FIGS. 14 through to 18, the actuator 102 having an inclined profile may further have steps 202 on the inclined area which provides an efficient push for the piston rod 110 to be displaced.

Further, as the delivery system of the present invention does not use any pivoted movable parts, the chances of dialer malfunction are reduced as compared to the existing ratio/dosage delivery systems.

The materials suitable for forming the piston rods and the propelling holder and stationary holder may be polyacetal or any other suitable polymeric material. The biasing members may be made of any suitable metal such as steel. The body, cap and the applicator sleeve may be formed of any suitable material such as polypropylene. The material for forming pistons may be any suitable polymeric material such as polypropylene, polyacetal or low-density polyethylene. The actuator and the dialer may be formed of acrylonitrile butadiene styrene or any suitable polymeric material. The applicator may be made from any suitable polymeric material such as acrylonitrile butadiene styrene, injection molded silicone or injection molded silicone. The applicator may also be made of a combination of both injection molded silicone and injection molded silicone. The aforementioned materials for forming various parts of the delivery system of the present invention are an example, however other suitable materials may also be used.

Although the above description and drawings show the delivery system, and in particular the body, actuator and dialer thereof, being cylindrical, the shapes and profile cross section thereof are not limited to the same.

Also, the applicator of the present invention could be cylindrical and slightly domed on top having concentric grooves with multiple orifices that contain the products when they are being dispensed. The applicator top could alternatively have concentric fins instead of grooves which help in mixing of the products during application. However, the applicator could have any suitable form to target a specific application.

Delivery system of the present invention can be used to dispense a wide variety of consumer and industrial products related to cosmetic, skin care, hair care, oral care, personal care, pharmaceutical, wound care, orally administrable products, home-care or adhesives.

The delivery system of the present invention may also be used for such consumer products where it is desirable to keep one or more of the components separate until just before dispensing them in the final product. It could be used in the cosmetic products that require a mixture of such ingredients that undesirably tend to break down if the components are allowed to co-exist together for an extended period of time. For example surfactant and conditioner ingredients in shampoos, surfactants and moisturizer ingredients in shower gels, vitamins in cosmetic preparations or the components of a hair dye could be stored and dispensed separately. The delivery system of present invention can also provide for variation of similar products for example different shades or flavors of lip-balm. The delivery system of the present invention could allow for use of many combinations of complementary products in certain pharmaceutical preparations.

Various examples of the products where the delivery system of the present invention could be used are but not limited to cheek blush, cheek plumping gel/cream, lip plumping gel/cream, moisturizer, sunscreen, temporary hair colors, hair styling gel, hair mousse, hair repair cream, hydrating cream, antiseptic and correction cream, acne treatment cream, concealer, blemish concealer, skin treatment cream, hair repair cream, anti-dandruff cream, hair treatment serum, scalp hydrating oils, teeth whitening gel, teeth whitening and teeth lamination solutions, pain relieving cream, antibiotic cream and analgesic cream, antipyretic and analgesic serums/solutions, bleaching agent, fabric softener, stain remover, bleaching agent and adhesive gels, among others.

The delivery system of present invention could also be used to dispense two products simultaneously wherein the two products dispensed are but not limited to cheek blush with vitamins, cheek blush with cheek plumping gel/cream, lip plumping gel/cream with moisturizer, temporary hair colors, hair styling gel with glitter, hair styling gel with colour, hair mousse with hair repair cream, exfoliant with hydrating cream, antiseptic and correction cream, acne treatment cream and concealer, blemish concealer with skin treatment cream, hair repair cream with anti-dandruff cream, hair treatment serum with scalp hydrating oils, teeth whitening gel with mouth wash, teeth whitening and teeth lamination solutions, pain relieving cream with cooling serum, antibiotic cream and analgesic cream, two active antibiotic creams, antipyretic and analgesic serums/solutions, bleaching agent with fabric softener, stain remover with sanitizer and bleaching agent with fragrant solution, among others, while in adhesives the two-part adhesives gel could be dispensed by the delivery system of the present invention.

While the foregoing is directed to embodiments of the present invention, other and further embodiments of the invention may be devised without departing from the basic scope thereof, and the scope thereof is determined by the claims that follow. Accordingly, the appended claims should be construed to encompass not only those forms and embodiments of the invention specifically described above, but to such other forms and embodiments as may be devised by those skilled in the art without departing from its true spirit and scope.

What is claimed is:

1. A delivery system for dispensing product in adjustable and/or variable quantities comprising:
a body, said body having at least one cavity wherein said cavity houses a product and a piston assembly;
an actuator arranged to be in communication with the cavity in the body, said actuator having an inclined profile at one of its ends that is in communication with the body; and
a means for changing the position of the inclined profile of the actuator with respect to the body;
wherein changing the position of the inclined profile of the actuator with respect to the body delivers different quantities of the product.

2. The delivery system according to claim 1 wherein the delivery system further comprises an applicator attached to the body.

3. The delivery system according to claim 2 wherein the actuator actuates the piston assembly when its end having an inclined profile is caused to align with the piston assembly.

4. The delivery system according to claim 3 wherein said means for changing the position of the inclined profile of the actuator with respect to the body is operatively connected to the actuator and said means causes the actuator to align with the piston assembly to dispense different ratios or dosages of product.

5. The delivery system according to claim 4 wherein the piston assembly comprises of a piston, a piston rod, an anti-slip jaw and a propeller jaw.

6. The delivery system according to claim 5 wherein the anti-slip jaw and propelling jaw are radially symmetrical components with cut outs in the centre, said cut-outs defining formation of flanges, said flanges making the jaw to be elastically deformable towards one axis.

7. The delivery system according to claim 6 wherein the piston assembly further comprises a stationary holder for holding the anti-slip jaw, a propelling holder for holding the propelling jaw and a biasing member biasing the movement of both the holders and in turn both the jaws.

8. The delivery system according to claim 7 wherein the piston rod is profiled wherein the profiles are means of engagement with the anti-slip and the propeller jaw.

9. The delivery system according to claim 8 wherein the means for changing the position of the inclined profile of the actuator and the actuator are biased by a biasing member that provides smooth actuation by the actuating member.

10. The delivery system according to claim 9 wherein the means for changing the position of the inclined profile of the actuator is preferably in the form of a dialer.

11. The delivery system according to claim 10 wherein the actuator is optionally arranged to be locked with respect to the means for changing the position of the inclined profile of the actuator in order that no actuation occurs.

12. The delivery system according to claim 11 wherein change in the position of the inclined profile of the actuator relative to the piston assembly causes a displacement of the piston rod and therefore the piston, resulting in dispensing of variable quantities of the product.

13. The delivery system according to claim 12 wherein the product comprise at least one of cosmetic, skin care, hair care, oral care, personal care, pharmaceutical, wound care, orally administrable products, home-care or adhesives.

14. A delivery system for dispensing at least two products in adjustable and/or variable proportions comprising:
a body, said body having at least two cavities, each cavity housing a product and a piston assembly;
an actuator arranged to be in communication with the cavities in the body, said actuator having an inclined profile at one of its ends that is in communication with the cavities in the body; and
a means for changing the position of the inclined profile of the actuator with respect to the body;
wherein the actuator actuates each of the piston assembly when its end having an inclined profile is caused to align with the piston assemblies of the two cavities and wherein changing the position of the inclined profile of the actuator with respect to the body delivers adjustable and/or variable proportions of the products.

15. The delivery system according to claim 14 wherein the delivery system optionally comprises an applicator attached to the body.

16. The delivery system according to claim 15 wherein said means for changing the position of the inclined profile of the actuator with respect to the body is operatively connected to the actuator and said means causes the actuator to align with the piston assemblies of the at least two cavities of the body to dispense adjustable and/or variable proportions of products.

17. The delivery system according to claim 16 wherein each of the piston assembly in the at least two cavities of the body comprises of a piston, a piston rod, an anti-slip jaw and a propeller jaw.

18. The delivery system according to claim 17 wherein each of the anti-slip jaw and propelling jaw are radially symmetrical components with cut outs in the centre, said cut-outs defining formation of flanges, said flanges making the jaw to be elastically deformable towards one axis.

19. The delivery system according to claim 18 wherein each of the piston assembly of the at least two cavities of the body further comprises a stationary holder for holding the anti-slip jaw, a propelling holder for holding the propelling jaw and a biasing member biasing the movement of both the holders and in turn both the jaws.

20. The delivery system according to claim 19 wherein the piston rod of each of the piston assemblies of the at least two cavities of the body is profiled wherein the profiles are means of engagement with the anti-slip and the propeller jaw and wherein the propeller jaw and the anti-slip jaw control the movement of the piston rod.

21. The delivery system according to claim 20 wherein the means for changing the position of the inclined profile of the actuator and the actuator are biased by a biasing member that provides smooth actuation by the actuating member.

22. The delivery system according to claim 21 wherein the means for changing the position of the inclined profile of the actuator is preferably in the form of a dialer.

23. The delivery system according to claim 22 wherein the actuator is optionally arranged to be locked with respect to the means for changing the position of the inclined end of the actuator in order that no actuation occurs.

24. The delivery system according to claim 23 wherein change in the position of the inclined profile of the actuator relative to the piston assemblies of the at least two cavities of the body causes a displacement of each of the piston rods and therefore each of the pistons, resulting in dispensing of variable proportions of the at least two products relative to one another.

25. The delivery system according to claim 24 wherein the at least two products comprise at least one of cosmetic, skin care, hair care, oral care, personal care, pharmaceutical, wound care, orally administrable products, home-care or adhesives.

26. A delivery system for dispensing products in adjustable and/or variable quantities comprising:
a body, said body having at least one product housing cavity and a piston assembly;
wherein the piston assembly comprises of a piston, a piston rod, an anti-slip jaw and a propeller jaw;
wherein the piston assembly further comprises a stationary holder for holding the anti-slip jaw, a propelling holder for holding the propelling jaw and a biasing member biasing the movement of both the holders and in turn both the jaws;
wherein the anti-slip jaw and propelling jaw are radially symmetrical components with cut outs in the centre, said cut-outs defining formation of flanges, said flanges making the jaw to be elastically deformable towards one axis;
wherein the piston rod is profiled wherein the profiles are means of engagement with the anti-slip and the propeller jaw;
an actuator arranged to be in communication with the cavity in the body, said actuator having an inclined profile at one of its ends that is in communication with the body and wherein the actuator actuates the piston and rod assembly when its end having an inclined profile is caused to align with the piston assembly;
a means for changing the position of the incline of the actuator with respect to the body;
wherein said means for changing the position of the incline profile of the actuator with respect to the body is operatively connected to the actuator and said means causes the actuator to align with the piston and rod assembly to dispense different ratios or dosages of products;
wherein the means for changing the position of the inclined profile of the actuator and the actuator are biased by a biasing member that provides smooth actuation by the actuating member;
wherein the means for changing the position of the inclined profile of the actuator is preferably in the form of a dialer;
wherein the delivery system further comprises an applicator attached to the body;
wherein the actuator is optionally arranged to be locked with respect to the means for changing the position of the inclined profile of the actuator in order that no actuation occurs;
wherein changing the position of the inclined profile of the actuator with respect to the body delivers different quantities of the products; and
wherein change in the position of the inclined profile of the actuator relative to the piston assembly causes a displacement of the respective piston rod(s) and therefore the pistons resulting in dispensing of variable quantities of the products.

27. A delivery system for dispensing at least two products in adjustable and/or variable proportions comprising:
a body, said body having at least two cavities for housing the two product and a piston assembly;
wherein each of the piston assembly in the at least two cavities of the body comprises of a piston, a piston rod, an anti-slip jaw and a propeller jaw;
wherein each of the anti-slip jaw and propelling jaw are radially symmetrical components with cut outs in the centre, said cut-outs defining formation of flanges, said flanges making the jaw to be elastically deformable towards one axis;
wherein each of the piston assembly of the at least two cavities of the body further comprises a stationary holder for holding the anti-slip jaw, a propelling holder for holding the propelling jaw and a biasing member biasing the movement of both the holders and in turn both the jaws;
wherein the piston rod of each of the piston assemblies of the at least two cavities of the body is profiled wherein the profiles are means of engagement with the anti-slip and the propeller jaw;
an actuator arranged to be in communication with the cavities in the body, said actuator having an inclined profile at one of its ends that is in communication with the body;
a means for changing the position of the inclined profile of the actuator with respect to the body;
wherein said means for changing the position of the inclined profile of the actuator with respect to the body is operatively connected to the actuator and said means causes the actuator to align with the piston and rod assemblies of the at least two cavities of the body to dispense adjustable and/or variable proportions of products;
wherein the means for changing the position of the inclined profile of the actuator and the actuator are biased by a biasing member that provides smooth actuation by the actuating member;
wherein the means for changing the position of the inclined profile of the actuator is preferably in the form of a dialer; and
wherein the actuator is optionally arranged to be locked with respect to the means for changing the position of the inclined profile of the actuator in order that no actuation occurs wherein the delivery system optionally comprises an applicator attached to the body wherein the actuator actuates each of the piston and rod assembly when its end having an inclined profile is caused to align with each of the piston assembly and wherein change in the position of the inclined profile of the actuator relative to the piston assemblies of the at least two cavities of the body causes a displacement of each of the piston rods and therefore each of the pistons, resulting in dispensing of variable proportions of the at least two products relative to one another.
